(19) United States
(12) Patent Application Publication
(10) Pub. No.: US 2016/0256895 A1
(43) Pub. Date: Sep. 8, 2016

(54) SCREENING DEVICE

(71) Applicant: Schenck Process GmbH, Darmstadt (DE)

(72) Inventors: Horst BIRNBAUM, Ober-Ramstadt (DE); Jan EHRENFELS, Riedstadt-Erfelden (DE)

(73) Assignee: Schenck Process GmbH, Darmstadt (DE)

(21) Appl. No.: 15/152,843

(22) Filed: May 12, 2016

Related U.S. Application Data
(63) Continuation of application No. PCT/EP2014/002999, filed on Nov. 10, 2014.

(30) Foreign Application Priority Data
Nov. 12, 2013 (DE) 10 2013 018 873.3

(51) Int. Cl. B07B 1/48

(52) U.S. Cl. CPC B07B 1/485; B07B 2201/04

(57) ABSTRACT

A screening device including elastic screen lining elements that are attached to first and second cross-bars, the first and second cross-bars being alternately arranged in a vibrationally driven frame of the screening device. The first cross-bars are rigidly connected to the frame, and the second cross-bars are mounted in the frame by means of spring elements. The frame has openings for accommodating the spring elements, the openings being located in a region of end faces of the second cross-bars.

This nonprovisional application is a continuation of International Application No. PCT/EP2014/002999, which was filed on Nov. 10, 2014, and which claims priority to German Patent Application No. 10 2013 018 873.3, which was filed in Germany on Nov. 12, 2013, and which are both herein incorporated by reference.

### BACKGROUND OF THE INVENTION

1. Field of the Invention

The present invention relates to a screening device.

2. Description of the Background Art

So-called lining-excited screening devices or screening machines are known from the prior art, in which the elastic screen lining elements are clamped between two cross-bars, each of which is assigned to a vibrating mass. The vibrating masses are usually vibrationally driven by a driving unit, and the second vibrating mass is coupled with the first vibrating mass in such a way that the elastic screen lining elements, which are arranged sequentially to form a screen lining, are periodically stretched and compressed. A high acceleration of the screening material in the vertical direction is generated thereby, which ensures that the screening material does not induce any deposits on the screen lining elements even in the event of high material moisture and long screening periods.

A lining-excited screening machine is known from EP 1 454 679 A1, which includes two frame-shaped vibrating bodies, each having cross-bars which are rigidly connected to the longitudinal frame, in which the second vibrating body is disposed within the first vibrating body. The first vibrating body is driven by a driving unit which is coupled directly thereto, while the second vibrating body is positively guided by the first vibrating body via an eccentric shaft, connected thereto via an elastic coupling element and elastically vibrationally coupled along at least two coupling axes. As a result, the second vibrating body, as the spring mass system, achieves greater vibration amplitudes than the directly driven vibrating body. The elastic screen linings are each clamped between the cross-bars of the first vibrating body and the cross-bars of the second vibrating body, so that they move back and forth between a stretched and a compressed position during the screening operation.

In contrast thereto, a screening machine having a screen surface is known from DE 4101710 A1, which corresponds to U.S. Pat. No. 5,193,689, which includes only one frame, in which the cross-bars are alternately supported in a rigid and spring-mounted manner. The screen lining elements are each fastened to the rigid and spring-mounted cross-bars. During the screening operation, the frame, in turn, is vibrationally driven, so that the screen lining elements also alternately pass through a compression and stretching phase, due to the different vibration behavior of the rigid and spring-mounted cross-bars.

EP 0 218 575 A2 furthermore shows a screening device, in which the elastic screen elements are fastened to cross-bars, which are movably supported in two diametrically opposed directions in a plane perpendicular to their longitudinal axes and are provided on both ends with a drive which sets them in motion.

### SUMMARY OF THE INVENTION

It is therefore an object of the present invention to improve a screening device, in which the structural design is simplified and increased variability is achieved.

In an embodiment of the present invention, a screening device is provided that includes elastic screen lining elements, which are fastened to first and second cross-bars. The first and second cross-bars are alternately disposed in a vibrationally driven frame of the screening device, the first cross-bars being rigidly connected to the frame and the second cross-bars being mounted in the frame by means of spring elements. The first cross-bars, together with the frame, which is also referred to as the sieve box, forms a first vibrating mass or a first motion system and executes a basic vibration. This basic vibration may be a linear or circular vibration, depending on the type of exciter. The second cross-bars, which are mounted on the frame by means of spring elements, represent a second vibrating mass or a second motion system. For this purpose, the frame has openings, for example in its side plates, in the area of the end faces of the second cross-bars, which are used to accommodate the spring elements. Due to the fact that only the first cross-bars, including the frame, or the first vibrating mass is/are driven, and the second cross-bars are spring-mounted or mounted in a freely vibrating manner, a relative movement results between the two cross-bar systems or the two vibrating masses or motion systems. This relative movement induces an alternating stretching and relaxing of the elastic screen lining elements. Since the second cross-bars, which can also be referred to as cross-beams, are each mounted by their two ends on the frame by means of a spring element, one also speaks of a single cross-beam bearing.

An embodiment of the invention furthermore provides that the spring elements can be disposed on the outside of the frame. This means that the spring elements are fastened outside the sieve chamber.

The spring elements can be replaceably fastened to the frame. The second cross-bars may also be introduced into the frame or sieve box, fastened, removed and/or replaced and/or connected to the spring elements through the openings in the frame. Since the life of the screen lining elements as well as that of the cross-bars and corresponding spring elements is limited as a result of the load of the screening material and the continuous vibratory load, the spring elements and cross-bars, in particular, must be replaced after a certain load period in order to avoid fatigue cracking or even fatigue fractures.

Since screening devices frequently have a box-like structure, the access to the cross-bars and spring elements is made much easier in the present invention, compared to screening devices from the prior art, which do not have any openings in the side plates of the frame. The spring elements are accommodated in the openings in the frame and have a connecting point for the second cross-bars, which are located in the interior of the sieve box or frame. Since all components of the second motion system may be very quickly replaced from outside the screening device, the screening devices according to the invention are extremely easy to service, since prolonged down times for maintenance are avoidable.

Another advantage in terms of the replaceability of the spring elements lies in that different operating parameters with regard to the vibration characteristics, in particular the resonance frequency, vibration amplitude and acceleration values, are implemented by different spring elements. Since an adjustment of the overall system must take place with different geometries or dimensions of the screening device, this may be easily accomplished by changing and replacing the spring elements without having to make any other structural changes to the frame or sieve box. The vibration behavior of the second cross-bars is significantly influenced by the design of the spring elements. Due to the different spring rigidities of a single spring element in different directions, for example in directions acting perpendicularly to each other, the direction of movement of the vibratory motion of the second cross-bar may be predetermined. A positive guidance for the second cross-bars thus results from the design of the spring elements. Accordingly, a linear guidance of the second cross-bars with respect to their vibration behavior is possible. Thus, a horizontal vibratory motion results from an increase in the spring rigidity of the spring elements in the vertical direction.

An embodiment of the invention also provides that the openings in the frame can be sealed dust-tight by the spring elements. As a result, the environment around the screening device may be sealed against the sieve chamber.

To connect the spring elements to the frame or the side plate, the spring elements may essentially include a rigid connecting element and an elastomer which is fixedly connected thereto. This elastomer may be provided, for example, in the shape of a cylinder, in the shape of a ring or in the shape of a hollow profile. The elastomers may also have different dimensions over their circumference with regard to the wall thicknesses.

In the case of hollow profile-shaped elastomers having a rectangular cross section, for example, the flange thickness and web thicknesses may be different. In addition, the spring element advantageously has the rigid connecting element, including a first connecting plate, for connecting and contacting the spring element to the frame. A straight or angular flange, in turn, is disposed or molded onto the first connecting plate, which is used to fasten or screw the spring element to the frame. The spring element may also include a second rigid connecting element, including a second connecting plate, for connection to a second cross-bar.

The spring element, which may also be referred to as a damping element, can include a vulcanized rubber element between two coupling elements made of metal. Coupling elements made of metal are provided as rigid connecting elements, which form a fixed, in particular shear-resistant, connection together with the rubber after the vulcanization of the rubber compound.

An embodiment of the invention furthermore provides that the elastomer or rubber element can have a circumferential groove. This circumferential groove, in turn, may have a conical cross-sectional shape, the groove being disposed on the side of the elastomer facing the screening material. The groove having the inclined side walls thus prevents the screening material that enters the area of the spring elements from adhering, so that it is instead automatically transported out of the opening again, due to the design of the elastomer and the movement of the vibrating device.

An embodiment of the invention also provides that the elastomer includes a sealing lip. This molded-on sealing lip is used to provide a dust-tight sealing of the opening in the frame or in the side plate of the screening device.

With the aid of the replaceable spring elements, it is possible, as described at the outset, to change the operating parameters of the entire screening device in such a way that the vibration behavior of the second cross-bars relative to the first cross-bars and the frame is controllable by the hardness of the elastomer. The vibration behavior of the second cross-bars may furthermore be controlled by means of the spring characteristic of the spring element, in particular by means of the ratio of the spring characteristics in the vertical and horizontal directions of the spring element. The entire machine adjustment and the determination of the resonant range of the two oscillatory masses may thus be easier to implement.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a perspective view of a screening device, including a frame having first rigidly fastened cross-bars as the first vibrating mass;

FIG. 2 shows a number of second cross-bars, which are to be fastened as individual supports and the second vibrating mass in the frame from FIG. 1;

FIG. 3 shows a perspective view of the overall vibrating system comprising the first and second vibrating masses, including the second cross-bars which are spring-mounted in the frame;

FIG. 4 shows an enlarged detail of the outside of the screening device, including an opening and a spring element, which is disposed in an opening in the frame;

FIG. 5 shows a perspective view of a spring element according to the invention, with a view of the side facing the inside of the screening device or the screening material;

FIG. 6 shows a view of the spring element from FIG. 5; and

FIG. 7 shows a section of the spring element from FIG. 6 along line VII-VII.

### DETAILED DESCRIPTION

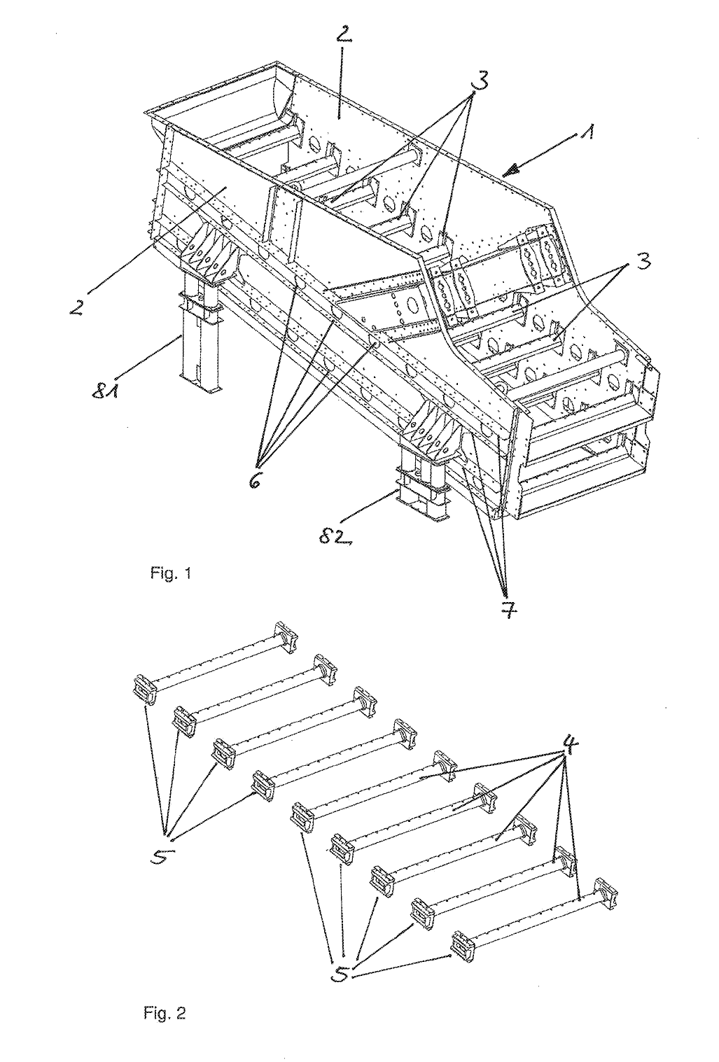

FIG. 1 shows a screening device according to the invention, which includes a first vibrating mass or a first motion system, in a perspective view from above. The screening device is a device which has two screening levels or two sieve decks disposed one above the other. The first vibrating mass includes a frame 1, which has two side plates 2, between which a number of first cross-bars 3 are disposed rigidly and in parallel to each other. Side plates 2, together with first cross-bars 3, thus form a rigid box body, the so-called sieve box, to which the drives or exciters (not illustrated) for generating the vibratory motion may be attached. Frame 1 is mounted on supports 81, 82, which have different lengths, whereby an inclined arrangement results for frame 1 and the screening level.

Cross-bars 3 are usually connected to side plates 2 by means of special huck bolts, so that a stress-free or low-stress construction results, which is able to withstand the continuous vibratory load.

FIG. 1 furthermore shows that openings 6 are provided in side plates 2 of frame 1. Openings 6 have a circular shape and are provided between first rigidly fastened cross-bars 3 in side plate 2. Additional reinforcement angles 7 and transverse ribs are also fastened to side plates 2 by means of huck bolts for stabilizing frame 1. Openings 6 are each disposed between two reinforcement angles 7 on each screening level.

FIG. 2 shows a number of second cross-bars 4, which are also built into frame 1 or the sieve box, in parallel to first cross-bars 3, which, however, represent a second vibratory mass or second motion system. In the case of illustrated cross-bars 4, spring elements 5 are already fastened to both ends of cross-bars 4.

Cross-bars 3, 4 of the screening device according to the invention have a cross section in the form of a rectangular hollow profile. The size of openings 6 in frame 1 is selected in such a way that second cross-bars 4 may be introduced therethrough into the interior of frame 1, the so-called sieve chamber, if spring elements 5 have not yet been mounted. In the installed state, second cross-bars 4 are fastened to side plate 2 in such a way that they are disposed, rotated 45° with respect to the rectangular position. A clamping or fastening device for the elastic screen linings is situated on the upwardly oriented edge of cross-bars 3, 4.

Arranging the elastic screen linings close together in series on multiple cross-bars 3, 4 results in a sieve deck extending through the screening device, along which the screening material may be transported from a feed area 10 to a discharge area 11 during the screening operation. During this movement, the oversize material defined by the screen lining openings is separated from the fine material, which passes through screen lining openings onto the underlying level, where it is carried away.

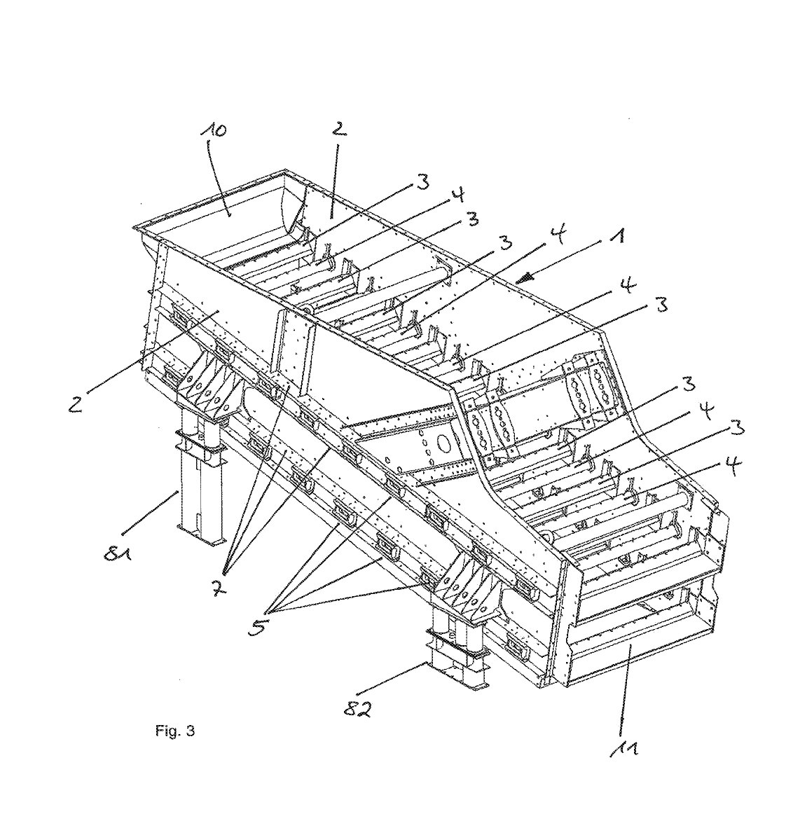

The overall system, comprising the first and second vibratory masses, is illustrated in FIG. 3. FIG. 3 shows that first cross-bars 3 and second cross-bars 4 are disposed alternately in frame 1 or the vibrating box. Lining-excited screening devices are frequently used for screening material which has a high degree of moisture. In vibratory screeners having rigid screen linings, screening material with a high degree of moisture runs the risk that the screening material closes the screen openings, and the screening operation is not efficient enough. Elastic screen linings (not illustrated) are therefore used for lining-excited screening devices, which are alternately stretched and compressed during the screening operation, so that they induce a vertical acceleration of the screening material. This substantially reduces the closing or clogging of the screen openings.

To stretch and compress the elastic screen linings, the screen linings are fastened by one side to a first cross-bar 3 and by the other side to a second cross-bar 4.

The motion coupling of first and second cross-bars 3, 4, and thus the first and second vibrating masses, takes place by means of the fastening of second cross-bars 4 in frame 1. In contrast to first cross-bars 3, second cross-bars 4 are not rigid but instead are connected to frame 1 or vibrating box by means of spring elements 5.

Spring elements 5 are fastened to side plate 2 from the outside of frame 1 and are accommodated by openings 6 provided for this purpose in side plate 2. Parts of spring elements 5 project into the sieve chamber of sieve box, so that second cross-bars 4 may be fastened thereto.

Second cross-bars 4 or the second vibrating mass are vibrationally coupled (independently of direction) to the first vibrating mass by elastic spring elements 5. As a result, the motion components applied by the drive to the first vibrating mass are absorbed by spring element 5 and transferred to second vibrating mass 4.

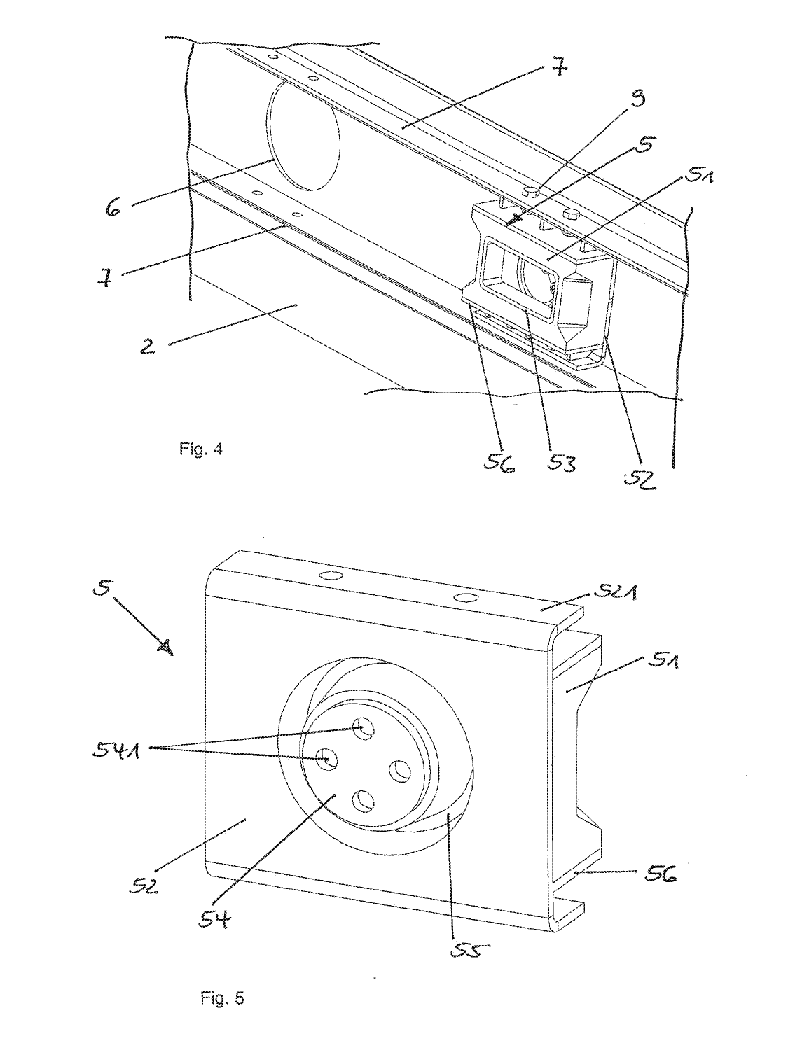

FIG. 4 shows an enlarged representation of one part of a side plate 2 of frame 1, which includes a circular opening 6 and a premounted spring element 5. Spring element 5, which is fastened to two reinforcement angles 7 of frame 1 by means of screws 9, completely covers and additionally seals opening 6. Spring element 5 includes two rigid connecting elements and an elastomer 51, which has a cross section in the shape of a hollow profile, the flanges and webs of the hollow profile having different thicknesses. Elastomer 51 is connected to one connecting element each via its inner shell as well as its outer shell. In addition to the coupling function, it also has a sealing function.

A spring element 5 for fastening second cross-bars 4 in frame 1 is illustrated in FIGS. 5 through 7 below.

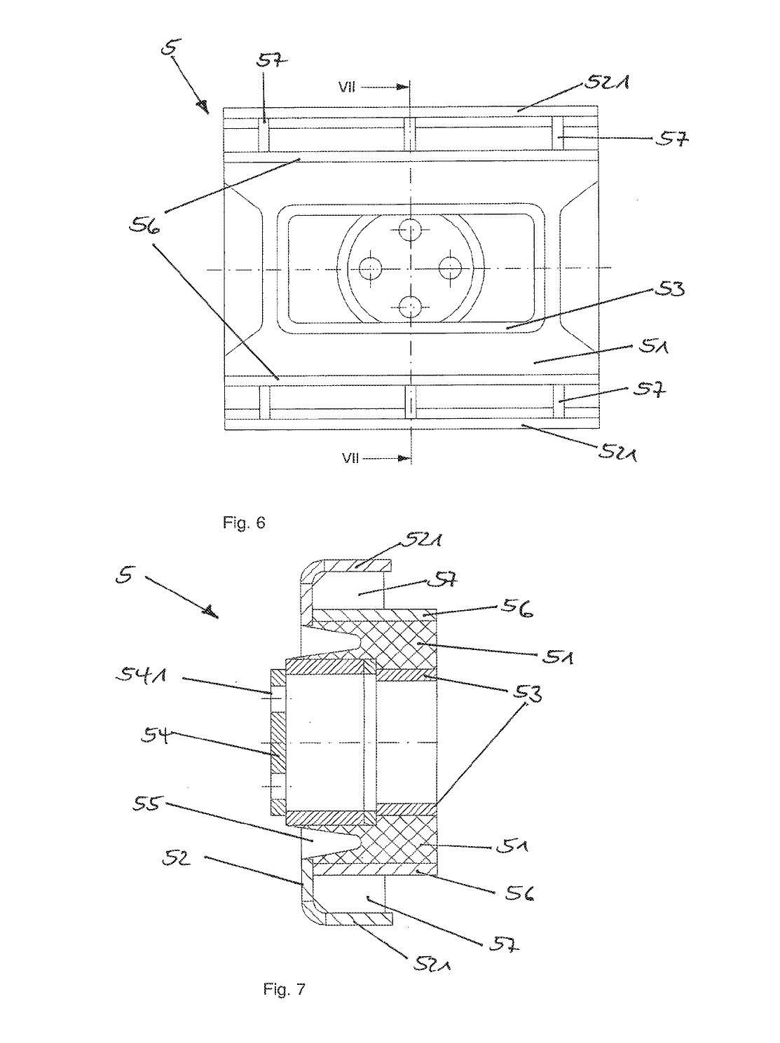

FIG. 5 shows a perspective view of spring element 5 from the side facing frame 1 and the sieve chamber. A first rigid connecting element includes a first connecting plate 52, with the aid of which spring element 5 abuts side plate 2 of frame 1. The first rigid connecting element also includes two angled flanges 521, via which spring element 5 is screwed to reinforcement angles 7 disposed on the outside of frame 1. It is apparent from FIGS. 6 and 7 that angled flanges 521 may be reinforced by additional ribs 57.

A second rigid connecting element, which includes a second connecting plate 54, is provided in the middle of spring element 5 and is used to fasten second cross-bars 4. For this purpose, second connecting plate 54 has a number of bore holes 541, which are used to screw spring elements 5 to end plates disposed on the end faces of second cross-bars 4. Both first connecting plate 52 and second connecting plate 54 are each fixedly connected to elastomer 51 by means of one coupling element 53, 56.

Coupling element 53, which is connected to second connecting plate 54, is disposed on the inner shell of hollow profile-shaped elastomer 51. Coupling element 53 therefore also has a hollow profile-shaped cross section. Coupling element 56, which is connected to first connecting plate 52, however, is disposed on the outer shell of elastomer 51. As a result, the rigid connecting elements of spring element 5 are coupled with each other only by elastomer 51. All forces which occur between frame 1 and second cross-bar 4, or between the first and second vibrating masses, must therefore be able to be absorbed by elastomer 51.

It is additionally apparent from FIG. 7 that elastomer 51 has a circumferential groove 55 on its side facing the sieve chamber. Groove 55 ensures the mobility of second cross-bars 4 in the connecting area. In addition, groove 55 has a conical shape in that its side walls are inclined in an internally directed or convergent manner. This prevents screening material that enters the groove area during the screening operation from adhering thereto.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A screening device comprising:
elastic screen lining elements that are fastened to first cross-bars and second cross-bars;
a vibrationally driven frame having the first cross-bars and the second cross-bars alternatively disposed therein, the first cross-bars being rigidly connected to the frame and the second cross-bars being mounted in the frame via spring elements; and
openings arranged in the frame in an area of end faces of the second cross-bars, which are provided to accommodate the spring elements.

2. The screening device according to claim 1, wherein the fastening of the spring elements is provided on an outside of the frame.

3. The screening device according to claim 1, wherein the spring elements are replaceably fastened to the frame.

4. The screening device according to claim 1, wherein the second cross-bars are introduced, fastened, removed and/or replaced and/or connected to the spring elements through the openings in the frame.

5. The screening device according to claim 1, wherein the openings in the frame are sealed dust-tight by the spring elements.

6. The screening device according to claim 1, wherein the spring elements comprise a first rigid connecting element having an elastomer that is fixedly connected thereto.

7. The screening device according to claim 6, wherein an essentially cylindrical, ring-shaped or hollow profile-shaped elastomer is provided for at least two of the spring elements.

8. The screening device according to claim 6, wherein the first rigid connecting element includes a first connecting plate for connecting the spring element to the frame.

9. The screening device according to claim 6, wherein a second rigid connecting element includes a second connecting plate for connecting the spring element to a second cross-bar.

10. The screening device according to claim 8, wherein the first and second connecting elements or the first and second connecting plates are coupled with each other by the elastomer.

11. The screening device according to claim 1, wherein the spring element includes a vulcanized elastomer made of rubber or polyurethane between two coupling elements made of metal.

12. The screening device according to claim 6, wherein a circumferential groove is provided in the elastomer.

13. The screening device according to claim 12, wherein the circumferential groove is provided with a conical cross section.

14. The screening device according to claim 12, wherein the groove is provided on the side of the elastomer facing the screening material.

15. The screening device according to claim 6, wherein a vibration behavior of the second cross-bars relative to the first cross-bars and the frame is controllable via a hardness of the elastomer.
